(19) United States
(12) Patent Application Publication
(10) Pub. No.: US 2009/0045960 A1
(43) Pub. Date: Feb. 19, 2009

(54) System And Method For Protecting RFID Cards From Unauthorized Interrogation

(76) Inventor: Robert J. von Gutfeld, New York, NY (US)

Correspondence Address: BAKER BOTTS L.L.P., 30 ROCKEFELLER PLAZA, 44TH FLOOR, NEW YORK, NY, 10112-4498, US

(21) Appl. No.: 12/052,200

(22) Filed: Mar. 20, 2008

Related U.S. Application Data
(60) Provisional application No. 60/908,778, filed on Mar. 29, 2007.

(51) Int. Cl. G08B 13/14

(52) U.S. Cl. 340/572.3

(57) ABSTRACT

Systems and methods for protecting radio frequency identification cards from unauthorized interrogation are provided herein. In some embodiments, the system includes a card having a first card portion, second card portion, and a spacer located between the first card portion and second card portion, each of the first and second card portions having an inner surface and an outer surface. A logic and memory chip is affixed to the inner surface of first card portion. An antenna is connected to the chip. The antenna has a gap that cause the antenna to be electrically discontinuous thereby making the chip inactive to interrogation. A spring-like member that has an electrically conducting portion is positioned in proximity to the gap in the antenna. The spring-like member can be selectively moved substantially across the gap to complete an antenna circuit and make the chip susceptible to interrogation.

### CROSS-REFERENCE TO RELATED APPLICATIONS

This application claims priority to U.S. Provisional Application Ser. No. 60/908,778, filed Mar. 29, 2007, which is hereby incorporated by reference in its entirety herein.

### TECHNICAL FIELD

The disclosed subject matter relates to a system and method for protecting radio frequency identification (RFID) cards from unauthorized interrogation.

### BACKGROUND

Credit cards and other types of personal identification cards with RFID (radio frequency identification) capabilities are becoming increasingly popular in the marketplace because merchants can scan or read the cards in a hands-free manner. For example, RFID cards that are issued by credit card companies or banks are held up to a card reader or scanner at a point of sale so that the merchandise can be properly paid for by the credit card. The cards do not have to be swiped by the cashier or customer. They are simply “waved” at the reader or scanner and interrogated. These cards are convenient, but they also pose a risk to the cardholders.

FIG. 9 depicts one example of an RFID card used by various banks. The card 2 includes a logic or memory chip 6 and a continuous antenna 4.

The risk of using such cards is that information transmitted by the card can be captured by a third party with an RFID reader. Because the standard card is normally active (i.e., in a state susceptible to interrogation), an individual with a small RFID reader can stand behind the customer and read the information on the card before, during, or after the occurrence of a legitimate transaction. As a result, the information on the card becomes stolen, unbeknownst to the card owner with the ensuing risks of illegitimate purchases and identity theft.

There is therefore a need for a system to protect RFID cards from unauthorized interrogation.

### SUMMARY

Systems and methods for protecting radio frequency identification cards from unauthorized interrogation are provided herein.

In some embodiments, the system includes a card having a first card portion, a second card portion, and a spacer located between the first card portion and the second card portion, in which each of the first and second card portions has an inner surface and an outer surface.

A logic and memory chip is affixed or attached to the inner surface of one of the first and second card portions. An antenna is connected to the chip and is also located on the inner surface of one of the first and second card portions. The antenna defines a gap that causes the antenna to be electrically discontinuous thereby making the chip inactive (i.e., insusceptible to interrogation).

The card also includes a spring-like or elastic-like member disposed on the inner surface of one of the first and second card portions. The spring-like member has an electrically conducting portion that is positioned adjacent to the gap in the antenna. The spring-like member can be selectively movable to bridge to complete the antenna, thereby completing an antenna circuit and making the chip susceptible to interrogation.

The system can further include a metallization layer covering at least a portion of the outer surface (or the inner surface) of the second card portion. The metallization layer can be made from metallized mylar, mu metal, aluminum, copper, chromium, titanium, iron, and/or another metal. The metallization layer can be deposited by vapor deposition. A thin sheet of metal can also be laminated on the outer surface of the second card portion. The metal should preferably have high attenuation for electrical or magnetic signals in order to prevent and/or inhibit unauthorized interrogation from the back of the card while the card is otherwise active.

The spring-like member can be located on the outer surface of the first or second card portions or positioned on a side or edge of the card. The spring-like member can be a spring-loaded member, soft button, slider, or elastomer.

The system can also include a magnetic stripe capable of being read by a magnetic stripe reader and located on the card in a region that does not interfere with the chip and the antenna.

The antenna can be a dipole antenna or a closed-loop antenna.

The spacer can be formed as a stepped rib located around a periphery of at least one of the card portions.

In other embodiments, the system includes a two-piece card having a first card portion comprising an inner surface and an outer surface and a second card portion comprising an inner surface and an outer surface, the first card portion and second card portion capable of being joined or laminated together. A logic and memory chip is affixed or attached to the inner surface of the one of the first or second card portions. A region of separation is located on the inner surface of one of the first and second card portions, the region having located therein an electrically conducting portion. An antenna is connected to the chip. The antenna has a gap and is located on the inner surface of the one of the first and second card portions. At least a portion of one of the first card portion and second card portion are selectively movable with respect to one another so as to dispose the electrically conducting portion across the gap in the antenna, thereby completing the antenna and making the chip susceptible to interrogation.

The system can also include a metallization layer covering at least a portion of the rear face of the one of the second card portion. The metallization layer can be made of metallized mylar, mu metal, aluminum, copper, chromium, titanium, iron, or other metals.

In other embodiments a system for protecting radio frequency identification cards from unauthorized interrogation is provided. The system includes a card including a first card portion and a second card portion, each card portion including an inner surface and an outer surface. A logic and memory chip is affixed or attached to the inner surface of one of the first and second card portions and an antenna is connected to the chip. The antenna is also located on the inner surface of one of the first and second card portion. A movable shield is located on the inner surface of one of the first and second card portions so that the shield covers at least a portion of the antenna. A spring-like member is disposed on the shield. The spring-like member is selectively movable so as to dispose the shield substantially away from the antenna and make the chip susceptible to interrogation.

The shield can comprise a slider. The slider can include an insulator layer and a metal layer. The insulator layer can be made of Teflon. The spring-like member can be, for example, a spring-loaded button.

The disclosed subject matter also includes a method for protecting radio frequency identification cards from unauthorized interrogation. The method includes providing a radio frequency identification card. The card includes a logic and memory chip, a radio frequency antenna connected to the chip, a gap in the antenna, and an electrically conducting portion located near the gap. The method also includes moving the electrically conducting portion into the gap to complete the antenna circuit and to activate the card. Next, a radio frequency signal from the card can be received. The signal can include data residing in the chip. The method also includes moving the electrically conducting portion out of the gap to de-activate the card.

In accordance with other embodiments, a system for protecting radio frequency identification cards from unauthorized interrogation is provided. The system includes a card including a first card portion, a second card portion, and means for providing space between the first and second card portions. Each of the first and second card portions has an inner surface and an outer surface. Storage means are disposed on the inner surface of one of the first and second card portions for storing data. Transmitting means are connected to the storage means. The transmitting means define a gap therein. The transmitting means being is located on the inner surface of one of the first and second card portions. The system also includes means for selectively moving an electrically conducting portion across the gap to complete the antenna and make the chip susceptible to interrogation.

### BRIEF DESCRIPTION OF THE DRAWINGS

Further features and advantages of the disclosed subject matter will become apparent from the following detailed description taken in conjunction with the accompanying figures showing illustrative embodiments of the disclosed subject matter, in which:

FIG. 1A is a block diagram showing a top view according to some embodiments of the disclosed subject matter.

FIG. 1B is a block diagram showing a side view according to some embodiments of the disclosed subject matter.

FIG. 2 is a block diagram showing a perspective view according to some embodiments of the disclosed subject matter.

FIG. 3 is a block diagram showing a top view according to some embodiments of the disclosed subject matter.

FIG. 4A is a block diagram showing a top view according to some embodiments of the disclosed subject matter.

FIG. 4B is a block diagram showing a side view according to some embodiments of the disclosed subject matter.

FIG. 5A is a block diagram showing a top view according to some embodiments of the disclosed subject matter.

FIG. 5B is a block diagram showing a side view according to some embodiments of the disclosed subject matter.

FIG. 6 is a block diagram showing a top view according to some embodiments of the disclosed subject matter.

FIG. 7A is an internal view according to some embodiments of the disclosed subject matter.

FIG. 7B is an internal view according to some embodiments of the disclosed subject matter.

FIG. 7C is a block diagram showing a side view according to some embodiments of the disclosed subject matter.

FIG. 8A is an internal view according to some embodiments of the disclosed subject matter.

FIG. 8B is an internal view according to some embodiments of the disclosed subject matter.

FIG. 8C is a block diagram showing a side view according to some embodiments of the disclosed subject matter.

FIG. 9 is a block diagram showing a top view of the prior art.

### DETAILED DESCRIPTION

The disclosed subject matter includes systems and methods for protecting radio frequency identification (RFID) cards from unauthorized interrogation. As RFID cards become increasingly popular and prevalent as a means for conducting transactions, it is important to provide adequate protection so that the information stored on the cards is not stolen or copied surreptitiously.

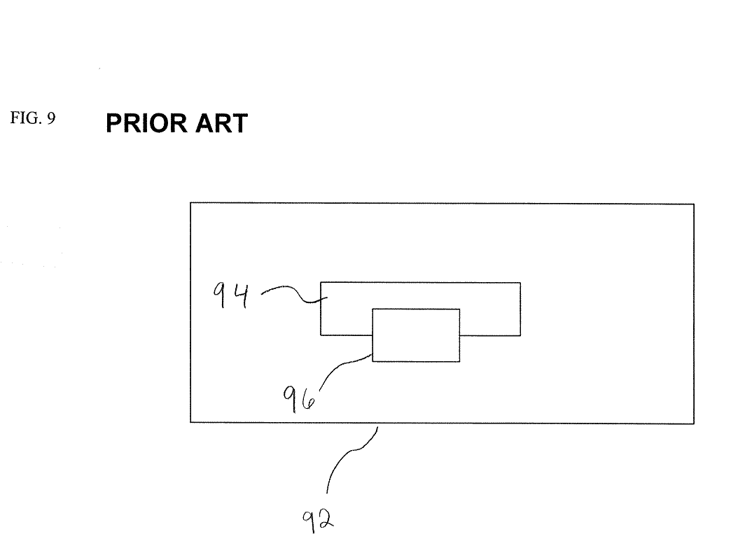

As shown in FIG. 9, one type of an RFID card 92 includes a memory chip 96 connected to a continuous antenna 94.

Another type of RFID cards uses an antenna that is disconnected from the memory chip in its inactive state. A user manually makes the connection between the chip and the antenna through the use of an additional assembly that includes a switch. A drawback to this type of card is that it requires an additional part. RFID cards are used frequently and often carelessly by users on a regular basis, leading to deterioration. Therefore, as the number of parts increase, so does the likelihood that one of the parts can malfunction or break entirely. Minimizing the number and complexity of the components is therefore desirable. Additionally, manufacturing costs are decreased if utilization of a switch assembly is not required.

In the disclosed subject matter, systems and methods for protecting RFID cards are provided which are durable and reliable. The systems and methods include a card with a chip connected to an antenna. The antenna has a gap so that the card cannot be interrogated without manual intervention. The gap in the antenna can be manually bridged by pressing a button (e.g., a spring-loaded button), sliding a slider or pressing the two opposite sides (e.g., front and back sides) of a card together, for example. The result is a simple and effective solution to the problem of protecting RFID cards from unauthorized interrogation.

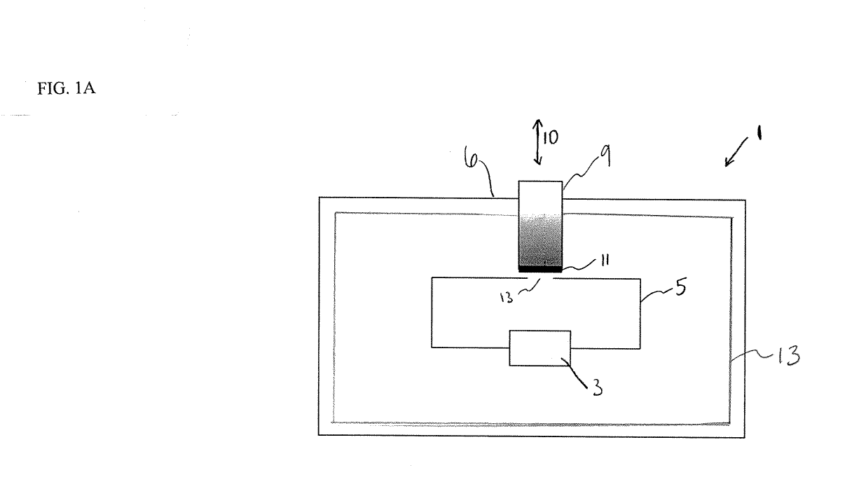

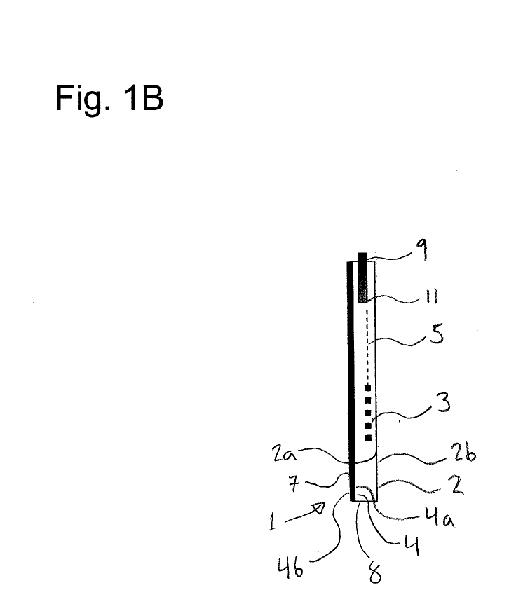

In one embodiment, as shown in FIGS. 1A and 1B, a system for protecting radio frequency identification cards from unauthorized interrogation is provided. The system includes a card 1 having a first card portion 2 and a second card portion 4. The first card portion 2 has an inner surface 2a and an outer surface 2b. The second card portion 4 has an inner surface 4a and an outer surface 4b. A logic and memory chip 3 is affixed or attached to the inner surface 2a of the first card portion 2, and an antenna 5 connected to the chip 3. The antenna 5 has a gap 13, and the gap 13 causes the antenna 5 to be electrically discontinuous so that the chip 3 is inactive to interrogation.

The system also includes a spring-like member 9 located on the card 1 that has an electrically conducting portion 11 positioned in proximity to the antenna gap 13. In one embodiment, the spring-like member 9 is a soft button. The spring-like member 9 is selectively movable and can be manually moved in a direction 10 towards antenna 5 to substantially bridge across the gap 13 in the antenna to complete the antenna circuit and make the chip 3 active to interrogation.

In one embodiment, the spring-like member is positioned on a side or edge 6 of the card 1, as shown in FIG. 1A. The spring-like member can be a slider or a soft button. Such buttons are well known in the art and are used in calculators, cell phones and the like.

The card portions 2 and 4 can be laminated together. The lamination can be in the form of a stepped rim 13 around the perimeter of the inner surfaces 2a, 4a of either card portion 2, 4. The rim can be approximately 25-100 microns in height.

The system can optionally include a metallization layer 7 covering at least a portion of outer surface 4b of the second portion 4 of the card 1. Alternatively, the metallization layer can cover at least a portion of outer surface 2b of the first portion 2 of the card 1, provided that the metallization layer faces away from the portion of the card through which the card is interrogated. The metallization layer 7 can be made of metallized mylar, mu metal, aluminum, copper, chromium, titanium, iron, or other metal. Preferably, metallized mylar is used. For high-frequency cards, typically in the 900 Mhz to 2 Ghz range, the metal can be in the range of about 100-300 nm. For lower frequency cards, where coupling from a base station or interrogation station is magnetic, typically in the range of 10 MHz, the layer can be a thin sheet of high permeability, such as mu metal, for example. The outer surface 4b can receive metallization by, e.g., vapor deposition or lamination of a sheet of metal on its surface, and/or other techniques known to those of ordinary skill in the art.

The metal can be applied to a mylar surface which in turn can be affixed to the outer surface 4b of the second portion 4 of the card. The thickness of the metal layer can be about 0.5 to 1 mm. The layer provides additional protection by inhibiting illicit interrogation from the back of the card, while the card is active. The card can be constructed with or without the metallization layer.

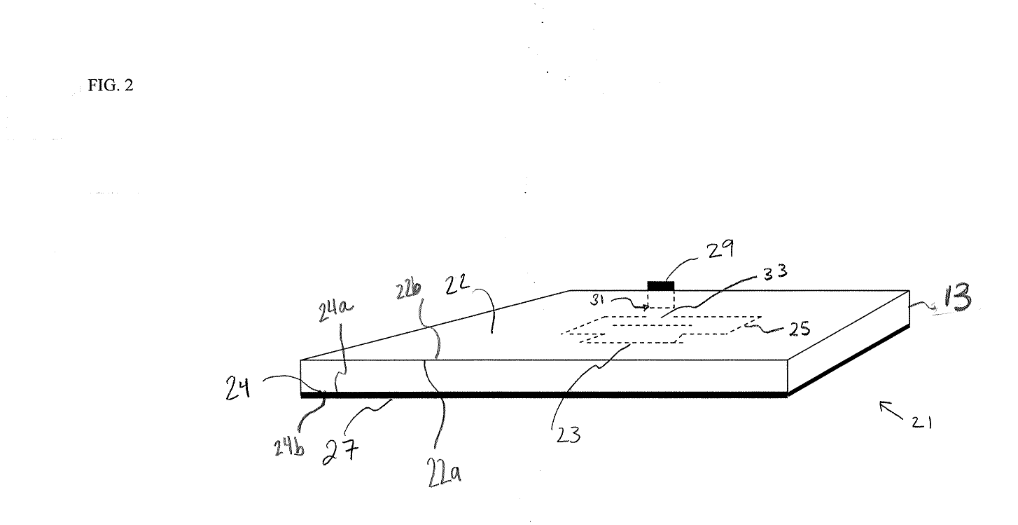

In other embodiments, as shown in FIG. 2, the spring-like member 29 is located on the first portion 22 of the card 21 and is selectively movable. The spring-like member 29 is pressed downward into the card 21 so that the electrically conducting portion 31 closes the gap 33 in the antenna 25, thereby completing the antenna circuit and activating the chip 23 for interrogation. The first card portion 22 has an inner surface 22a and an outer surface 22b. There is a spacer 13 between the first card portion 22 and the second card portion 24. The spacer 13 can be a stepped rib, for example. Optionally, a metallization layer, as described above, 27 covers at least a portion of the outer face 24b of the second portion 24 of the card 21.

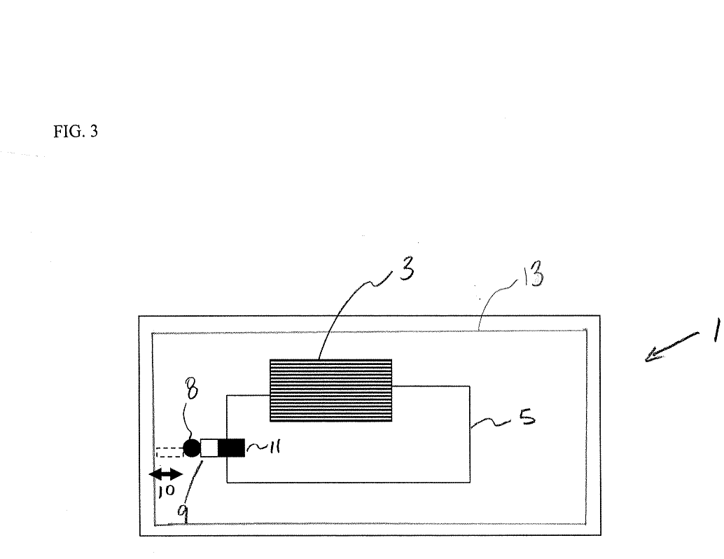

As shown in FIG. 3, the spring-like member 9 of the card 1 can include a slider 8 that moves in direction 10 perpendicular to the gap so that the electrically conducting portion 11 is disposed substantially across the gap in the antenna 5, thereby completing the antenna and making the chip 3 susceptible to interrogation. A stepped rim can be 13 formed around the perimeter of the card 1. The rim can be approximately 25-100 microns in height.

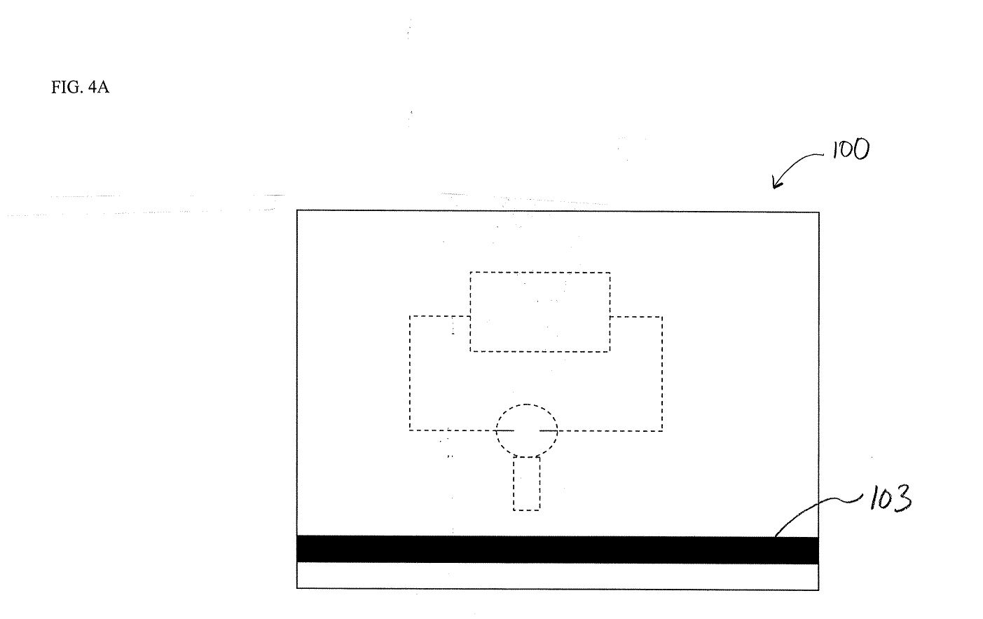

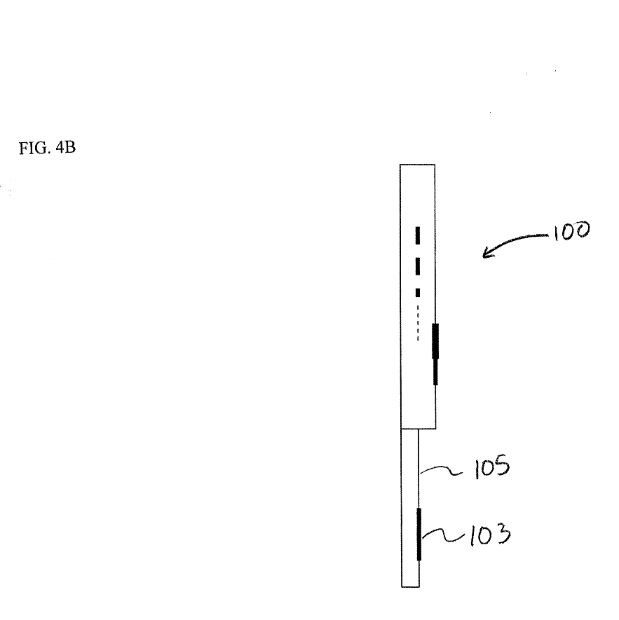

As shown in FIGS. 4A and 4B, the system can optionally include a magnetic stripe 103 located on the card 100. The magnetic stripe 103 is capable of being read by a magnetic stripe reader (not shown). The magnetic stripe 103 can be located on a thin portion 105 of the card 100. The magnetic stripe 103 makes the card dual-purpose in that it can be read by a traditional magnetic reader or by an RFID reader, as described above.

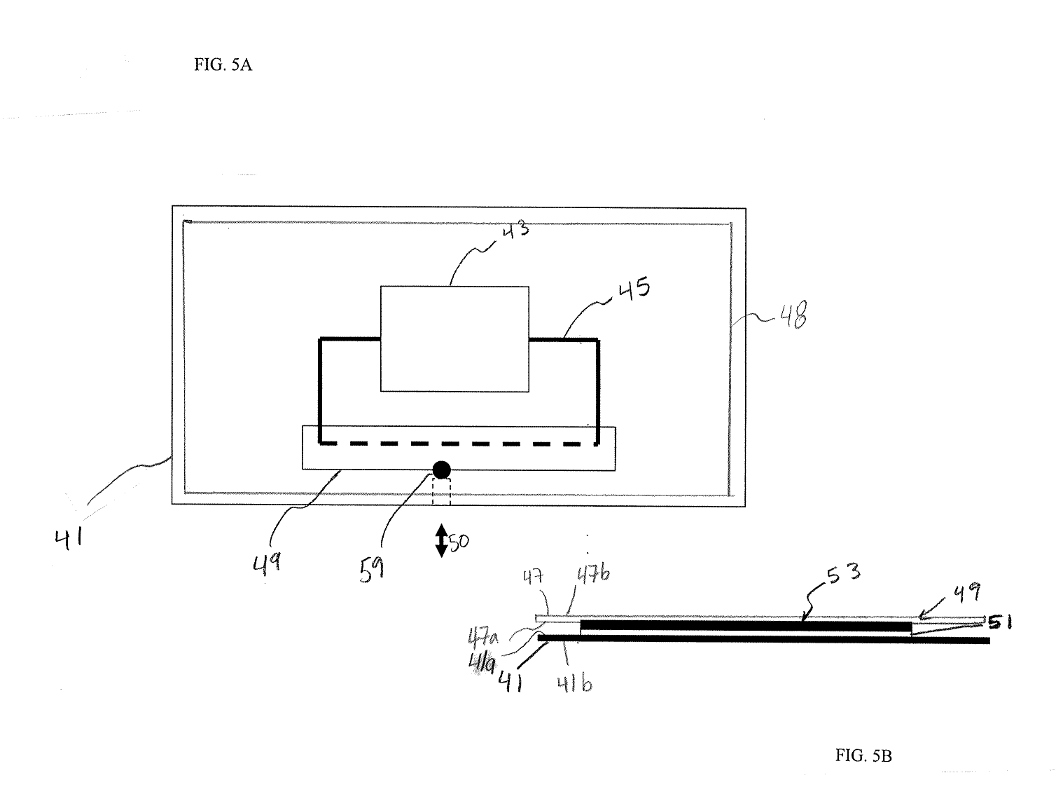

In other embodiments, as shown in FIGS. 5A and 5B, the antenna 45, which is connected to the chip 43, is continuous, i.e., does not have a gap. The system comprises a card comprising a first card portion 41 and a second card portion 47. The first card portion 41 includes an inner surface 41a and an outer surface 41b. The second card portion 47 includes an inner surface 47a and an outer surface 47b. A logic and memory chip 43 is affixed to the inner surface 41a of the first card portion 41.

A movable shield 49 is located on the inner surface 47a of the second card portion 47. The shield 49 inhibits and/or prevents the interrogation signal from reaching the antenna 45. The shield 49 covers at least a portion of the antenna 45 so that the chip is inactive to interrogation. A spring-like button 59 is attached to the shield 49. The button 59 can be manually operated to move in a direction 50 away from the antenna to move the shield 49 to expose the antenna 45 to make the chip 43 susceptible to interrogation. The shield 49 can be in the shape of a slider. The shield 49 can include an insulator layer 51 and a metal layer 53. The insulator is preferably made of teflon, but other insulating materials can also be used. FIG. 5A shows the shield 49 in a position that electrically shields the antenna 45. This design is useful for high frequency RFID cards (e.g., tags used as part of inventory control systems, for example) where high frequency implies electric coupling rather than magnetic coupling. When the card is to be interrogated in an authorized manner, a spring-like button 59 on the front of the card is selectively movable and can be pulled down to expose the antenna by removing the shield 49. When the button 59 is moved in direction 50 away from the antenna, the antenna 45 can receive interrogation signals and can respond with a normal encoded reflected signal.

The card portions 41 and 47 can be laminated together. The lamination can be in the form of a stepped rim 48 around the perimeter of the inner surfaces of either card portion 41 and 47. The rim can be approximately 25-100 microns in height.

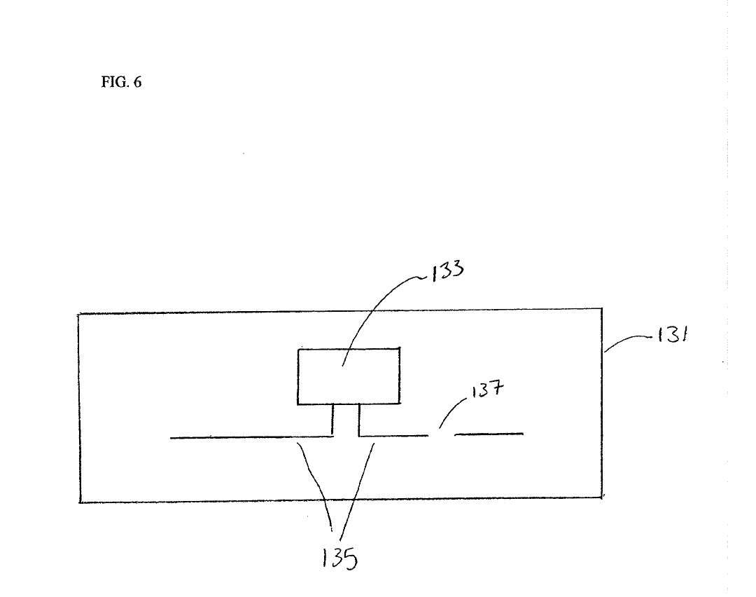

Optionally, any of the embodiments described herein can be such that the card 131 includes a dipole antenna 135, as depicted in FIG. 6. The dipole antenna 135 is connected to the chip 133 and has a gap 137. The gap can be bridged as described in any of the other embodiments.

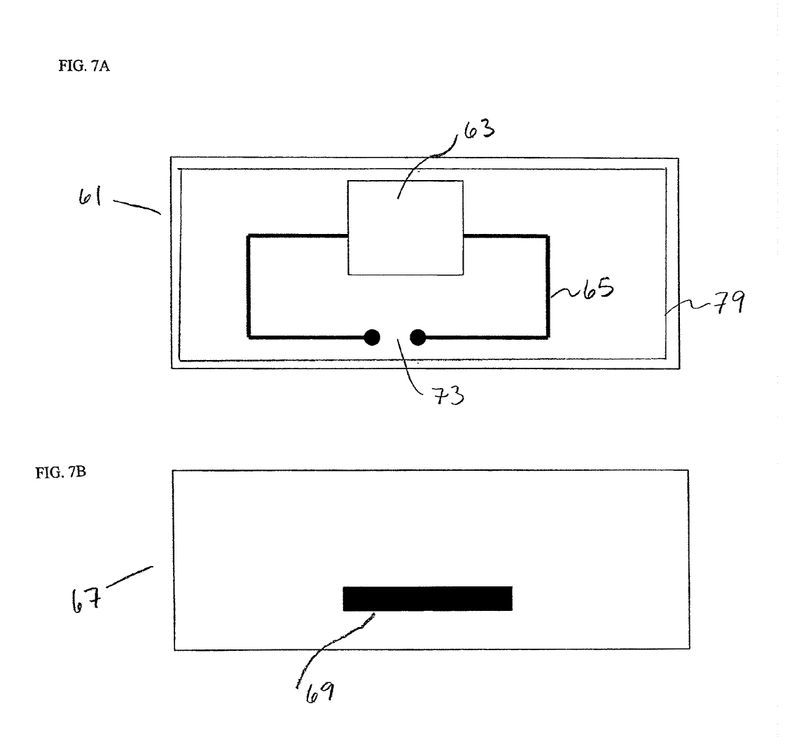

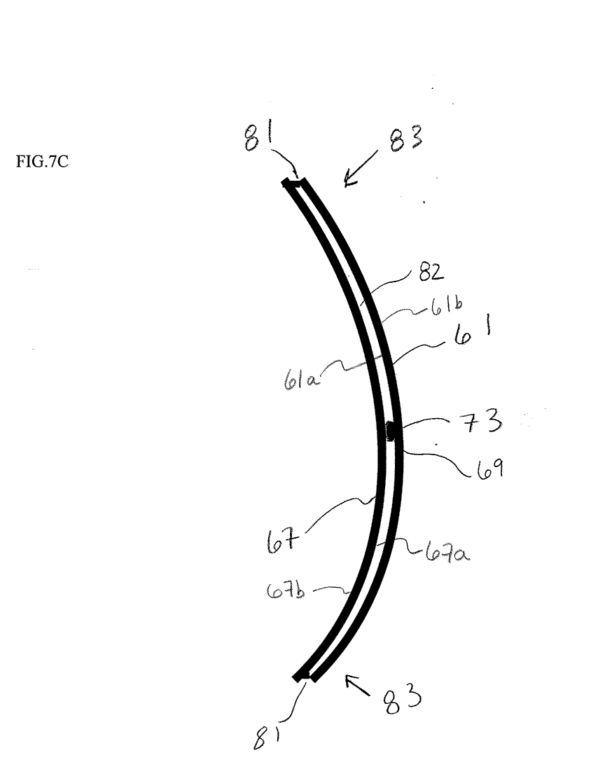

In other embodiments, as depicted in FIGS. 7A, 7B and 7C, a system for protecting radio frequency identification cards from unauthorized interrogation includes a two-piece card which has a first card portion 61, as shown in FIG. 7A, including an inner surface 61a and an outer surface 61b and a second card portion 67, as shown in FIG. 7B, also including an inner surface 67a and an outer surface 67b. The first card portion 61 and second card portion 67 are capable of being laminated together at edges 81, forming a region of separation 82 between the two pieces, as shown in FIG. 7C. The system also includes an electrically conducting portion 69 located in the region of separation 82 and a logic and memory chip 63 affixed to the inner surface 61a of first card portion 61, as shown in FIG. 7A. There is also an antenna 65 connected to the chip. The antenna 65 has a gap 73, which causes the antenna 65 to be electrically discontinuous thereby making the chip 63 inactive to interrogation.

The card portions 61 and 67 are laminated so that electrically conducting portion 69 faces antenna 65 opposite to antenna gap 73 but without it making contact with antenna 65 when the card is not flexed. The lamination can be in the form of a stepped rim 79 around the perimeter of the inner surfaces 61a, 67a of either card portion 61, 67. The rim can be approximately 25-100 microns in height.

In the system, as shown in FIG. 7C, at least one of the second card portion 67 and first card portion 61 can be manually moved to so that the electrically conducting portion is substantially across the gap 73 in the antenna 65, thereby completing an antenna circuit and making the chip 63 susceptible to interrogation. The manual movement can include flexing the card as indicated by arrows 83. Preferably, the first card portion 61 is made more rigid than the second card portion 67. However, either one of the two card portions can be made more rigid (made from a harder plastic) than the other. This assures contact when the card is flexed. Releasing the flexure again brings the card into an inactive state.

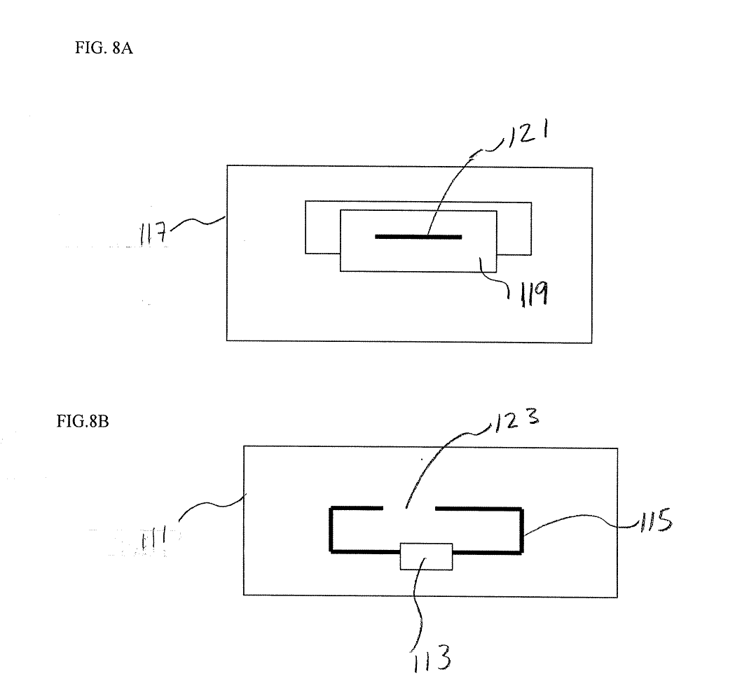

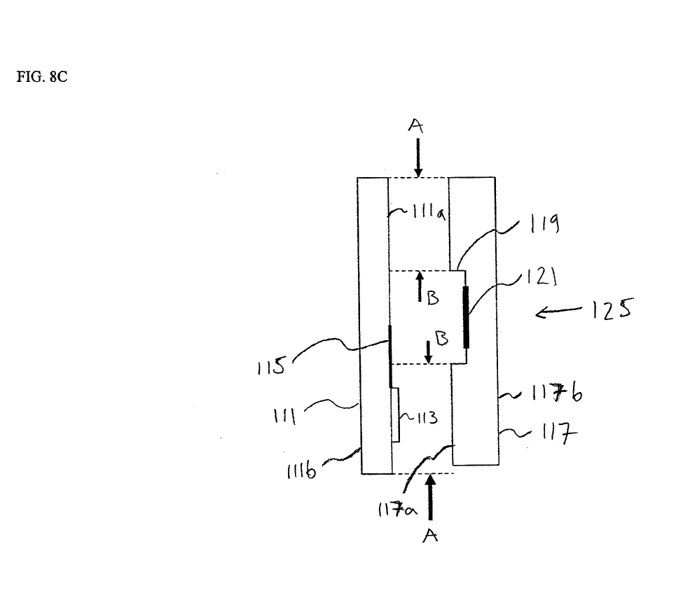

In a preferred embodiment, as shown in FIGS. 8A, 8B, and 8C, the system includes a two-piece card having a first card portion 111 and a second card portion 117. The first card portion 111 has an inner surface 111a and an outer surface 111b. The second card portion 117 has an inner surface 117a and an outer surface 117b. A logic and memory chip 113 is affixed to the inner surface 111a of the first card portion 111. An antenna 115 is connected to the chip 113. A region of indentation 119 can be located on the second card portion 117 and can have a depth of between about 25-200 microns. The electrically conducting portion 121 is located in the region of indentation 119, defined by arrows B.

When the first card portion 111 is manually pushed, because of the elasticity of the card portions, in direction 125 or when the two pieces 111 and 117 are pushed together, the electrically conducting portion 121 bridges the gap 123 in the antenna 115, thereby activating the chip 113 for interrogation. In this embodiment, the two card portions are laminated together along edges A. This type of system can also be used for magnetic coupling where the gap 123 is in a portion of a magnetic loop (not shown) that serves as an antenna.

In some embodiments, a method for protecting radio frequency identification cards from unauthorized interrogation is provided. The method, as shown, for example, in FIGS. 8A, 8B and 8C, includes providing a two-piece card having a first card portion 111 and a second card portion 117. The first card portion 111 has an inner surface 111a and an outer surface 111b. The second card portion 117 has an inner surface 117a and an outer surface 117b. The first card portion 111 and second card portion 112 are capable of being joined together. The method also includes providing an electrically conducting portion 121 located in a region of indentation 119 and a logic and memory chip 113 affixed to the second card portion 117. The method also includes providing an antenna 115 connected to the chip 113. The antenna 115 has a gap 123, such that the gap 123 causes the antenna 115 to be electrically discontinuous thereby making the chip 113 inactive to interrogation. The method also includes manually moving, in direction 125, the first card portion 111 so that the electrically conducting portion 121 bridges the gap 123 in the antenna 115, thereby completing an antenna circuit and making the chip 113 active to interrogation.

In other embodiments, a method for protecting radio frequency identification cards from unauthorized interrogation is disclosed. The method includes providing a radio frequency identification card. The card includes a logic and memory chip, a radio frequency antenna connected to the chip, a gap in the antenna, and an electrically conducting portion located near the gap.

The method also includes moving the electrically conducting portion into the gap to complete the antenna circuit and to activate the card. This can be accomplished by pressing two portions of the card together or by flexing the card, for example.

Next, a radio frequency signal from the card can be received by an interrogator. The signal can include data residing in the chip. For example, if the card is being used to purchase an item at a store, the user's account information can reside in the chip and the retailer can receive the account information by interrogating the card once the card is activated.

The method also includes moving the electrically conducting portion out of the gap to make the card inactive. Once the electrically conducting portion is out of the gap, the card can is no longer susceptible to interrogation.

In accordance with other embodiments, a system for protecting radio frequency identification cards from unauthorized interrogation is provided. The system includes a card including a first card portion, a second card portion, and means for providing space between the first and second card portions. Each of the first and second card portions has an inner surface and an outer surface. Storage means are disposed on the inner surface of one of the first and second card portions for storing data. Transmitting means are connected to the storage means. The transmitting means define a gap therein. The transmitting means is located on the inner surface of one of the first and second card portions. The system also includes means for selectively moving an electrically conducting portion across the gap to complete the antenna and make the chip susceptible to interrogation.

The foregoing merely illustrates the principles of the invention. Various modifications and alterations to the described embodiments will be apparent to those skilled in the art in view of the teachings herein. It will thus be appreciated that those skilled in the art will be able to devise numerous techniques which, although not explicitly described herein, embody the principles of the disclosed subject matter and are thus within its spirit and scope. It will also be apparent to those skilled in the art that various combinations, modifications, rearrangement and variations can be made to the disclosed subject matter without departing from its spirit or scope. Thus, it is intended that the disclosed subject includes combinations, modifications, rearrangements and variations that are within the scope of the appended claims and their equivalents.

1. A system for protecting radio frequency identification cards from unauthorized interrogation, the system comprising:
a card comprising a first card portion, a second card portion, and a spacer located between the first card portion and the second card portion, each of the first and second card portions having an inner surface and an outer surface;
a logic and memory chip disposed on the inner surface of one of the first and second card portions;
an antenna connected to the chip, the antenna defining a gap therein, the antenna being disposed on the inner surface of one of the first and second card portions;
a spring-like member disposed on the inner surface of one of the first and second card portions, and having an electrically conducting portion disposed adjacent the gap, the spring-like member being selectively moveable so as to dispose the electrically conducting portion substantially across the gap to complete the antenna and make the chip susceptible to interrogation.

2. The system of claim 1, further comprising a metallization layer covering at least a portion of the outer surface of the second card portion.

3. The system of claim 2, wherein the metallization layer comprises at least one of metallized mylar, mu metal, aluminum, copper, chromium, titanium, and iron.

4. The system of claim 1, wherein the spring-like member is disposed on the outer surface of the second card portion.

5. The system of claim 1, wherein the spring-like member is disposed on a side of the card.

6. The system of claim 1, wherein the spring-like member comprises one of a spring-loaded member, soft button, slider, and elastomer.

7. The system of claim 1, further comprising a magnetic portion disposed on the card for enabling the card to be read by a magnetic reader.

8. The system of claim 1, wherein the antenna comprises a dipole antenna.

9. The system of claim 1, wherein the spacer comprises a stepped rib disposed around a periphery of at least one of the card portions.

10. A system for protecting radio frequency identification cards from unauthorized interrogation, the system comprising:
a two-piece card having a first card portion comprising an inner surface and an outer surface and a second card portion comprising an inner surface and an outer surface;
a logic and memory chip affixed to the inner surface of one the first and second card portions;
a region of separation disposed on the inner surface of one of the first and second, the region having disposed therein an electrically conducting portion;
an antenna connected to the chip, the antenna defining a gap, the antenna being disposed on the inner surface of one of the first and second card portions;
wherein at least a portion of one of the first card portion and second card portion are selectively moveable with respect to one another so as to dispose the electrically conducting portion across the gap to complete the antenna and make the chip susceptible to interrogation.

11. The system of claim 10, further comprising a metallization layer covering at least a portion of the of the second card portion.

12. The system of claim 11, wherein the metallization layer comprises at least one of metallized mylar, mu metal, aluminum, copper, chromium, titanium, and iron.

13. A system for protecting radio frequency identification cards from unauthorized interrogation, the system comprising:
a card comprising a first card portion and a second card portion, each of the first and second card portions comprising an inner surface and an outer surface;
a logic and memory chip disposed on the inner surface of one of the first and second card portions;
an antenna connected to the chip, the antenna being disposed on the inner surface of one of the first and second card portions;
a movable shield located on the inner surface of one of the first and second card portions, the shield covering at least a portion of the antenna; and
a spring-like member disposed on the shield, the spring-like member being selectively moveable so as to dispose the shield substantially away from the antenna to expose the antenna and make the chip susceptible to interrogation.

14. The system of claim 13, wherein the shield comprises a slider.

15. The system of claim 14, wherein the slider comprises an insulator layer and a metal layer.

16. The system of claim 15, wherein the insulator layer comprises teflon.

17. The system of claim 13, wherein the spring-like member is a spring-loaded button.

18. A method for protecting radio frequency identification cards from unauthorized interrogation, the method comprising:
providing a radio frequency identification card comprising a logic and memory chip, a radio frequency antenna connected to the chip, a gap in the antenna, and an electrically conducting portion located near the gap;
moving the electrically conducting portion into the gap to complete the antenna circuit and to make the card active;
receiving a radio frequency signal from the card, the signal comprising data residing in the chip; and
moving the electrically conducting portion out of the gap to make the card inactive.

19. A system for protecting radio frequency identification cards from unauthorized interrogation, the system comprising:
a card comprising a first card portion, a second card portion, and means for providing space between the first and second card portions, each of the first and second card portions having an inner surface and an outer surface;
storage means disposed on the inner surface of one of the first and second card portions for storing data;
transmitting means connected to the storage means, the transmitting means defining a gap therein, the transmitting means being disposed on the inner surface of one of the first and second card portions;
means for selectively moving an electrically conducting portion across the gap to complete the antenna and make the chip susceptible to interrogation.
